(19) United States
(12) Patent Application Publication
(10) Pub. No.: US 2019/0042142 A1
(43) Pub. Date: Feb. 7, 2019

(54) STATISTICS AND PRIORITY-BASED CONTROL FOR STORAGE DEVICE

(71) Applicant: Intel Corporation, Santa Clara, CA (US)

(72) Inventors: Jason Casmira, North Plains, OR (US); Jawad Khan, Portland, OR (US); Ambika Krishnamoorthy, Folsom, CA (US); Sanjeev Trika, Portland, OR (US)

(21) Appl. No.: 15/857,954

(22) Filed: Dec. 29, 2017

(51) Int. Cl. G06F 3/06; G06F 11/34; G06F 11/30

(52) U.S. Cl. CPC G06F 3/0653; G06F 11/3433; G06F 3/0679; G06F 3/0604; G06F 3/0659; G06F 11/3034

(57) ABSTRACT

An embodiment of a semiconductor apparatus may include technology to monitor one or more external performance indicators related to a workload impact on a persistent storage media, monitor one or more internal performance indicators for the persistent storage media, and adjust the workload based on the external performance indicators, the internal performance indicators, and priority information related to the workload. Other embodiments are disclosed and claimed.

### TECHNICAL FIELD

Embodiments generally relate to storage systems. More particularly, embodiments relate to statistics and priority-based control for a storage device.

### BACKGROUND

Self-Monitoring, Analysis, and Reporting Technology (SMART) is described in the Advanced Technology Attachments (ATA) standards (e.g., ATA Command Set 2, Revision 7, published Jun. 22, 2011). The SMART standard may specify a way to signal information between a host system and a storage device. While some of the high-level information is standardized, various attributes may be implementation specific.

### BRIEF DESCRIPTION OF THE DRAWINGS

The various advantages of the embodiments will become apparent to one skilled in the art by reading the following specification and appended claims, and by referencing the following drawings, in which:

FIG. 1 is a block diagram of an example of an electronic processing system according to an embodiment;

FIG. 2 is a block diagram of an example of a semiconductor apparatus according to an embodiment;

FIGS. 3A to 3B are flowcharts of an example of a method of controlling persistent storage according to an embodiment;

FIG. 4 is a block diagram of an example of priority engine apparatus according to an embodiment;

FIGS. 5A to 5C are illustrative diagrams of an example of a runtime environment according to an embodiment; and

FIG. 6 is a flowchart of an example of a method of monitoring metrics according to an embodiment.

### DESCRIPTION OF EMBODIMENTS

Various embodiments described herein may include a memory component and/or an interface to a memory component. Such memory components may include volatile and/or nonvolatile memory. Nonvolatile memory may be a storage medium that does not require power to maintain the state of data stored by the medium. In one embodiment, the memory device may include a block addressable memory device, such as those based on NAND or NOR technologies. A memory device may also include future generation nonvolatile devices, such as a three dimensional crosspoint memory device, or other byte addressable write-in-place nonvolatile memory devices. In one embodiment, the memory device may be or may include memory devices that use chalcogenide glass, multi-threshold level NAND flash memory, NOR flash memory, single or multi-level Phase Change Memory (PCM), a resistive memory, nanowire memory, ferroelectric transistor random access memory (FeTRAM), anti-ferroelectric memory, magnetoresistive random access memory (MRAM) memory that incorporates memristor technology, resistive memory including the metal oxide base, the oxygen vacancy base and the conductive bridge Random Access Memory (CB-RAM), or spin transfer torque (STT)-MRAM, a spintronic magnetic junction memory based device, a magnetic tunneling junction (MTJ) based device, a DW (Domain Wall) and SOT (Spin Orbit Transfer) based device, a thiristor based memory device, or a combination of any of the above, or other memory. The memory device may refer to the die itself and/or to a packaged memory product. In particular embodiments, a memory component with non-volatile memory may comply with one or more standards promulgated by the Joint Electron Device Engineering Council (JEDEC), such as JESD218, JESD219, JESD220-1, JESD223B, JESD223-1, or other suitable standard (the JEDEC standards cited herein are available at jedec.org).

Volatile memory may be a storage medium that requires power to maintain the state of data stored by the medium. Non-limiting examples of volatile memory may include various types of RAM, such as dynamic random access memory (DRAM) or static random access memory (SRAM). One particular type of DRAM that may be used in a memory module is synchronous dynamic random access memory (SDRAM). In particular embodiments, DRAM of a memory component may comply with a standard promulgated by JEDEC, such as JESD79F for DDR SDRAM, JESD79-2F for DDR2 SDRAM, JESD79-3F for DDR3 SDRAM, JESD79-4A for DDR4 SDRAM, JESD209 for Low Power DDR (LPDDR), JESD209-2 for LPDDR2, JESD209-3 for LPDDR3, and JESD209-4 for LPDDR4 (these standards are available at www.jedec.org). Such standards (and similar standards) may be referred to as DDR-based standards and communication interfaces of the storage devices that implement such standards may be referred to as DDR-based interfaces.

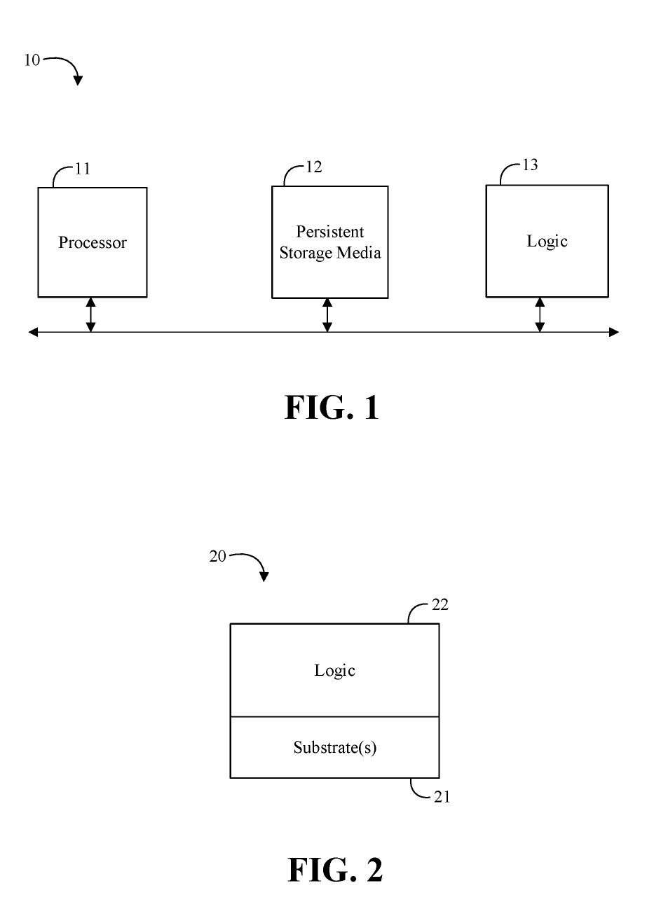

Turning now to FIG. 1, an embodiment of an electronic processing system 10 may include a processor 11, persistent storage media 12 communicatively coupled to the processor 11, and logic 13 communicatively coupled to the processor 11 and persistent storage media 12 to monitor one or more external performance indicators related to a workload impact on the persistent storage media 12, monitor one or more internal performance indicators for the persistent storage media 12, and adjust the workload based on the external performance indicators, the internal performance indicators, and priority information related to the workload. For example, the logic 13 may be configured to monitor a submission queue depth for one of the external performance indicators, and monitor an internal command scheduling queue depth for one of the internal performance indicators. In some embodiments, the logic 13 may additionally or alternatively be configured to monitor a write amplification parameter for one of the internal performance indicators. For example, the logic 13 may be configured to monitor a plurality of write amplification parameters including one or more of a write amplification parameter per submission queue, a write amplification per storage set, a write amplification per namespace, and a write amplification per stream. In some embodiments, the logic 13 may additionally or alternatively be configured to monitor one or more of transfer buffer usage, number of writes, size of writes, number of reads, and size of reads for the external performance indicators. For example, the persistent storage media 12 may include a solid state drive (SSD). In some embodiments, the logic 13 may be located in, or co-located with, various components, including the processor 11 (e.g., on a same die).

Embodiments of each of the above processor 11, persistent storage media 12, logic 13, and other system components may be implemented in hardware, software, or any suitable combination thereof. For example, hardware implementations may include configurable logic such as, for example, programmable logic arrays (PLAs), field programmable gate arrays (FPGAs), complex programmable logic devices (CPLDs), or fixed-functionality logic hardware using circuit technology such as, for example, application specific integrated circuit (ASIC), complementary metal oxide semiconductor (CMOS) or transistor-transistor logic (TTL) technology, or any combination thereof.

Alternatively, or additionally, all or portions of these components may be implemented in one or more modules as a set of logic instructions stored in a machine- or computer-readable storage medium such as random access memory (RAM), read only memory (ROM), programmable ROM (PROM), firmware, flash memory, etc., to be executed by a processor or computing device. For example, computer program code to carry out the operations of the components may be written in any combination of one or more operating system (OS) applicable/appropriate programming languages, including an object-oriented programming language such as PYTHON, PERL, JAVA, SMALLTALK, C++, C# or the like and conventional procedural programming languages, such as the “C” programming language or similar programming languages. For example, the persistent storage media 12, or other system memory may store a set of instructions which when executed by the processor 11 cause the system 10 to implement one or more components, features, or aspects of the system 10 (e.g., the logic 13, monitoring one or more external performance indicators related to a workload impact on the persistent storage, monitoring one or more internal performance indicators for the persistent storage, adjusting the workload based on the external performance indicators, the internal performance indicators, and priority information related to the workload, etc.).

Turning now to FIG. 2, an embodiment of a semiconductor apparatus 20 may include one or more substrates 21, and logic 22 coupled to the one or more substrates 21, wherein the logic 22 is at least partly implemented in one or more of configurable logic and fixed-functionality hardware logic. The logic 22 coupled to the one or more substrates may be configured to monitor one or more external performance indicators related to a workload impact on a persistent storage media, monitor one or more internal performance indicators for the persistent storage media, and adjust the workload based on the external performance indicators, the internal performance indicators, and priority information related to the workload. For example, the logic 22 may be configured to monitor a submission queue depth for one of the external performance indicators, and monitor an internal command scheduling queue depth for one of the internal performance indicators. In some embodiments, the logic 22 may additionally or alternatively be configured to monitor a write amplification parameter for one of the internal performance indicators. For example, the logic 22 may be configured to monitor a plurality of write amplification parameters including one or more of a write amplification parameter per submission queue, a write amplification per storage set, a write amplification per namespace, and a write amplification per stream. In some embodiments, the logic 22 may additionally or alternatively be configured to monitor one or more of transfer buffer usage, number of writes, size of writes, number of reads, and size of reads for the external performance indicators. For example, the persistent storage media may include a SSD. In some embodiments, the logic 22 coupled to the one or more substrates 21 may include transistor channel regions that are positioned within the one or more substrates.

Embodiments of logic 22, and other components of the apparatus 20, may be implemented in hardware, software, or any combination thereof including at least a partial implementation in hardware. For example, hardware implementations may include configurable logic such as, for example, PLAs, FPGAs, CPLDs, or fixed-functionality logic hardware using circuit technology such as, for example, ASIC, CMOS, or TTL technology, or any combination thereof. Additionally, portions of these components may be implemented in one or more modules as a set of logic instructions stored in a machine- or computer-readable storage medium such as RAM, ROM, PROM, firmware, flash memory, etc., to be executed by a processor or computing device. For example, computer program code to carry out the operations of the components may be written in any combination of one or more OS applicable/appropriate programming languages, including an object-oriented programming language such as PYTHON, PERL, JAVA, SMALLTALK, C++, C# or the like and conventional procedural programming languages, such as the “C” programming language or similar programming languages.

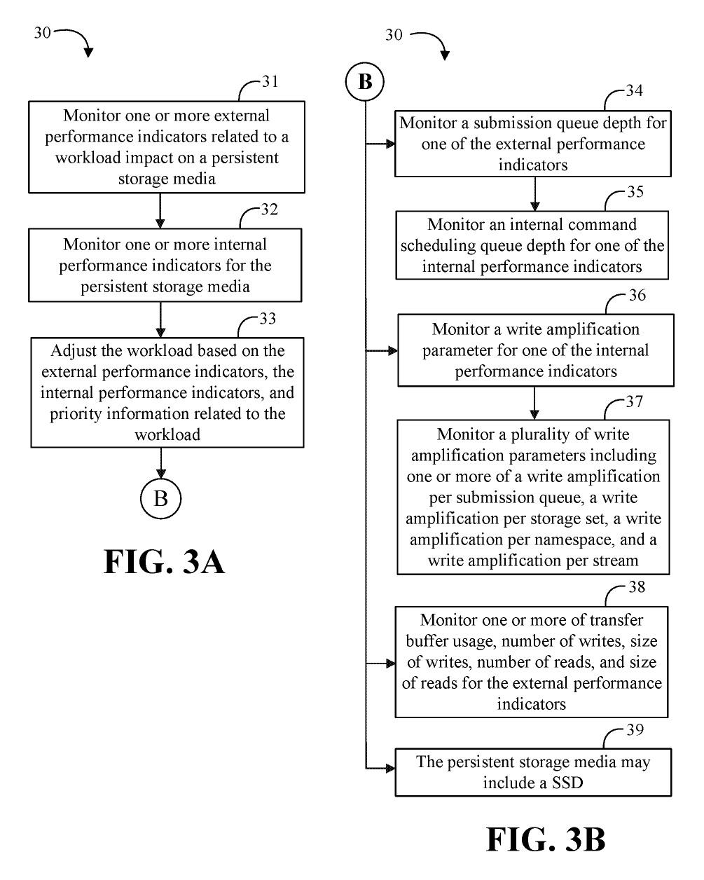

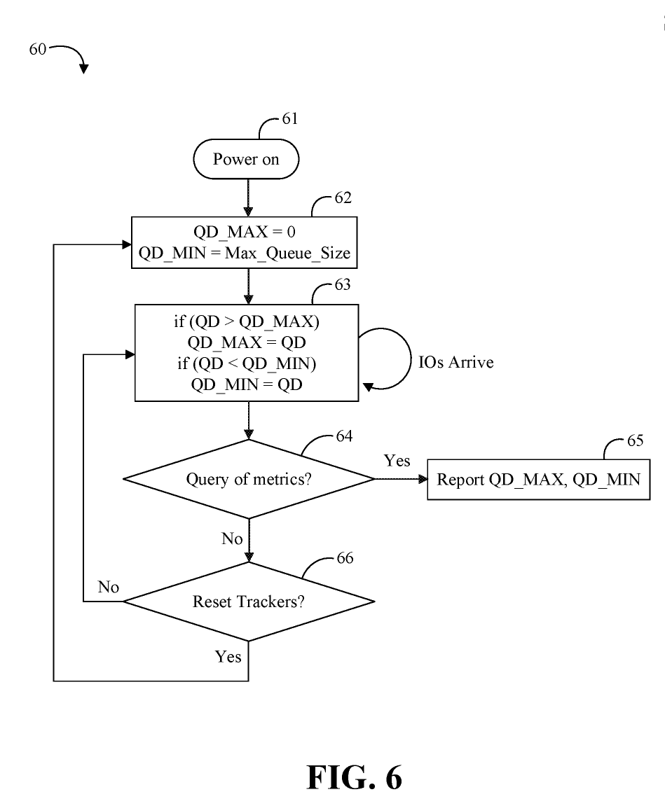

The apparatus 20 may implement one or more aspects of the method 30 (FIGS. 3A to 3C), the method 60 (FIG. 6), or any of the embodiments discussed herein. The illustrated apparatus 20 includes one or more substrates 21 (e.g., silicon, sapphire, gallium arsenide) and logic 22 (e.g., transistor array and other integrated circuit/IC components) coupled to the substrate(s) 21. The logic 22 may be implemented at least partly in configurable logic or fixed-functionality logic hardware. In one example, the logic 22 may include transistor channel regions that are positioned (e.g., embedded) within the substrate(s) 21. Thus, the interface between the logic 22 and the substrate(s) 21 may not be an abrupt junction. The logic 22 may also be considered to include an epitaxial layer that is grown on an initial wafer of the substrate(s) 21.

Turning now to FIGS. 3A to 3B, an embodiment of a method 30 of controlling persistent storage may include monitoring one or more external performance indicators related to a workload impact on a persistent storage media at block 31, monitoring one or more internal performance indicators for the persistent storage media at block 32, and adjusting the workload based on the external performance indicators, the internal performance indicators, and priority information related to the workload at block 33. For example, the method 30 may include monitoring a submission queue depth for one of the external performance indicators at block 34, and monitoring an internal command scheduling queue depth for one of the internal performance indicators at block 35. Some embodiments of the method 30 may additionally or alternatively include monitoring a write amplification parameter for one of the internal performance indicators at block 36. For example, the method 30 may include monitoring a plurality of write amplification parameters including one or more of a write amplification per submission queue, a write amplification per storage set, a write amplification per namespace, and a write amplification per stream at block 37. Some embodiments of the method 30 may additionally or alternatively include monitoring one or more of transfer buffer usage, number of writes, size of writes, number of reads, and size of reads for the external performance indicators at block 38. For example, the persistent storage media may include a SSD at block 39.

Embodiments of the method 30 may be implemented in a system, apparatus, computer, device, etc., for example, such as those described herein. More particularly, hardware implementations of the method 30 may include configurable logic such as, for example, PLAs, FPGAs, CPLDs, or in fixed-functionality logic hardware using circuit technology such as, for example, ASIC, CMOS, or TTL technology, or any combination thereof Alternatively, or additionally, the method 30 may be implemented in one or more modules as a set of logic instructions stored in a machine- or computer-readable storage medium such as RAM, ROM, PROM, firmware, flash memory, etc., to be executed by a processor or computing device. For example, computer program code to carry out the operations of the components may be written in any combination of one or more OS applicable/appropriate programming languages, including an object-oriented programming language such as PYTHON, PERL, JAVA, SMALLTALK, C++, C# or the like and conventional procedural programming languages, such as the “C” programming language or similar programming languages.

For example, the method 30 may be implemented on a computer readable medium as described in connection with Examples 19 to 24 below. Embodiments or portions of the method 30 may be implemented in firmware, applications (e.g., through an application programming interface (API)), or driver software running on an operating system (OS).

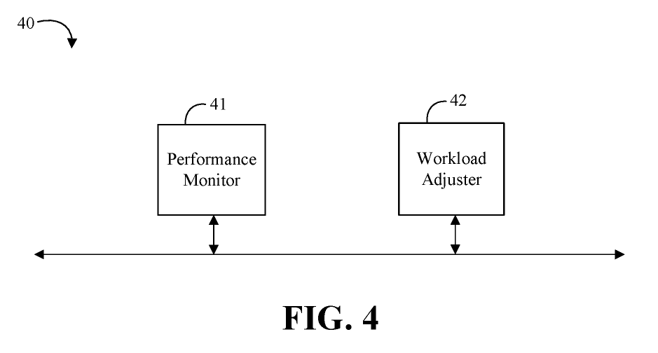

Turning now to FIG. 4, an embodiment of a priority engine apparatus 40 may include a performance monitor 41 and a workload adjuster 42. The performance monitor 41 may include technology to monitor one or more external performance indicators related to a workload impact on a persistent storage media, and to monitor one or more internal performance indicators for the persistent storage media. The workload adjuster 42 may include technology to adjust the workload based on the external performance indicators, the internal performance indicators, and priority information related to the workload. For example, the priority information may be based on a characteristic of the workload such as a media stream requiring higher priority. Additionally, or alternatively, the priority information may be based on a service level agreement (SLA) which allocates prioritized access to resources based on agreements with one or more subscribers to the resources (e.g., servers, cloud services, etc.).

In some embodiments, the performance monitor 41 may be configured to monitor a submission queue depth for one of the external performance indicators, and monitor an internal command scheduling queue depth for one of the internal performance indicators. In some embodiments, the performance monitor 41 may additionally or alternatively be configured to monitor a write amplification parameter for one of the internal performance indicators. For example, the performance monitor 41 may be configured to monitor a plurality of write amplification parameters including one or more of a write amplification parameter per submission queue, a write amplification per storage set, a write amplification per namespace, and a write amplification per stream. In some embodiments, the performance monitor 41 may additionally or alternatively be configured to monitor one or more of transfer buffer usage, number of writes, size of writes, number of reads, and size of reads for the external performance indicators. For example, the persistent storage media may include one or more SSDs as part of a cloud storage service.

Embodiments of the performance monitor 41, the workload adjuster 42, and other components of the priority engine apparatus 40, may be implemented in hardware, software, or any combination thereof including at least a partial implementation in hardware. For example, hardware implementations may include configurable logic such as, for example, PLAs, FPGAs, CPLDs, or fixed-functionality logic hardware using circuit technology such as, for example, ASIC, CMOS, or TTL technology, or any combination thereof. Additionally, portions of these components may be implemented in one or more modules as a set of logic instructions stored in a machine- or computer-readable storage medium such as RAM, ROM, PROM, firmware, flash memory, etc., to be executed by a processor or computing device. For example, computer program code to carry out the operations of the components may be written in any combination of one or more OS applicable/appropriate programming languages, including an obj ect-oriented programming language such as PYTHON, PERL, JAVA, SMALLTALK, C++, C# or the like and conventional procedural programming languages, such as the “C” programming language or similar programming languages.

Some embodiments may advantageously provide statistics and/or priority-based control for SSD devices. Some other systems may find it difficult to accurately identify a root-cause and/or fix some storage performance problems. For example, determining whether an issue is caused by the storage device or by something else in the system (e.g., application, OS, other hardware (HW), etc.), may be difficult or not possible without using intrusive and/or expensive tools. For example, information reported by some other SSDs may be insufficient to correctly diagnose some performance problems. For example, during runtime the system may not be able to determine if the workload running on the system is the cause (e.g., by issuing input/output (TO) requests to the storage system in an unbalanced fashion), or if the drive is causing the performance degradation (e.g., through queuing or scheduling). Some other SMART-compliant drives may report some drive information to the host, but may not include information or attributes with enough insight to address some performance problems. Advantageously, some embodiments may monitor external and internal performance indicators which may be dynamically used during runtime to adjust a workload for better IO performance (e.g., based on priority-related information). For example, some embodiments may determine whether the host driver submission queues and/or a connected SSD's internal command scheduling queues are balanced or imbalanced, if any determined imbalance is causing performance degradation for a priority workload, and, if so, adjusting the overall workload to alleviate the imbalance and improve the performance for the priority workload.

Some other storage performance debug applications may utilize telemetry and metrics above the storage device and driver (e.g., higher in the storage stack). These types of metrics do not give sufficient insight to determine definitively if some observed performance issues are caused by the workload/application/OS/environment, or from the drive itself. Advantageously, some embodiments may extend storage drive and/or driver statistics to provide metrics with significantly deeper visibility to drive performance. The metrics may be provided to a priority-engine, to application-based drive analysis/debugging tools, or to a human for drive analysis/debugging. For example, the priority-engine/debugger may then use the information to identify root-cause(s) of any problem(s), and to adjust the workload distribution to improve performance. For example, a priority-engine may provide effective dynamic adjustment at the host of a drive's resources with the improved visibility into the drive's resource usage. In some embodiments, the dynamic adjustment may advantageously enable application-defined storage capabilities. For example, a priority-engine may provide a host agent which may query and adjust the resource usage(s) that impact SLAs for various clients/VMs/apps/etc. Some embodiments may be implemented in products such as SSDs, OS applications, and/or third-party applications (e.g., drive analysis tools). Some embodiments may be implemented in services such as dynamic storage-SLA adjustment services (e.g., cloud-based storage services).

Non-limiting examples of useful performance indicators in accordance with some embodiments include Non-Volatile Memory Express (NVMe) submission queue depth, SSD internal command scheduling queue depth, write-amplification (e.g., per NVMe queue, NVM set, namespace, and stream), transfer buffer usage (e.g., per NVMe queue, NVM set, and namespace), number of writes (e.g., per queue, set, and namespace), megabytes written (e.g., per queue, set, and namespace), number of reads (e.g., per queue, set, and namespace), megabytes read (e.g., per queue, set and namespace), etc. For example, real-time metrics (e.g., and/or their respective minimum, maximum, average/standard-deviation/etc. values over a period of time) may be captured and available for query. In some embodiments, the time-period start and/or stop may be host-controlled.

Any suitable technique may be utilized to extract the identified performance indicators/metrics and to report the same from the SSD to the host. In some embodiments, the telemetry may be retrieved in multiple ways (e.g., SMART extensions, vendor specific commands, IOCTL mechanisms to get driver statistics, etc.). Given the benefit of the present specification and drawings, those skilled in the art may readily identify other indicators of performance, control-variables of SLAs, and/or other metrics that may be useful for drive performance analysis, dynamic workload adjustment, drive performance debug, SLA-control, etc.

Performance Monitoring Examples

Metrics may be calculated and/or updated in either the SSD and/or on the host side (e.g., in a storage driver), depending on the metric. The current value of some of the metrics may be calculated at any given time (e.g., on demand). Some embodiments may also track minimum and maximum values (e.g., and if needed average and standard deviation using appropriate sampling interval) over a period of time controlled by the host. Some or all of the statistics may be made available to the priority/SLA-engine/application/user as needed.

Queue depths: The storage driver may maintain the current size of each of the NVMe queues. The SSD may be configured to track current depth and/or usage of the internal scheduling queues.

Write-amplification (WA): The WA may be monitored per source (e.g., per NVMe queue, NVM set, namespace, and/or stream). An embodiment of a first technique may include a simplified SSD-simulator that consumes write-requests and calculates the WA associated with those writes based on underlying SSD assumptions (e.g., overprovisioning, page size, erase block (EB) size, threshold values, etc.). For example, the SSD-simulator may be embedded in the driver and/or in the SSD. The simulator may be instantiated per queue/set/namespace/stream. The simulator may deploy similar NAND management techniques as the real SSD. The writes may also proceed down the normal (e.g., non-simulator) path. An embodiment of a second technique may track the source associated with each write in non-volatile page metadata, and in band journals. The source may include information about the queue/set/namespace/stream including, for example, identification information. For example, a page metadata may indicate that the page data was written by a write request/command to queue number X, to set Y of namespace Z, using stream-identifier N (e.g., where N, X, Y, Z may correspond to non-zero integers or other suitable identification information). The identification information may allow real-time calculation of the WA for each of these sources. For example, the drive may maintain a count of incoming writes for the source, and lookup the source of the internal write at runtime from the metadata/band journal. The first technique may be more memory and compute intensive, but may be easier to implement in some embodiment. The second technique may be more complex, but may be more accurate and less compute intensive.

Transfer buffer usage per source: Some embodiments may track transfer buffer usage by updating the count of items for that source as the items are placed/removed in the transfer buffer due to host writes. In some embodiments, defragmentation writes may be ignored for the purpose of transfer buffer usage, because the defragmentation writes may be accounted for in the WA statistics.

Write statistics per source: Some embodiments may track write statistics by tracking the count and Mbyte size of write requests processed per source.

Read statistics per source: Some embodiments may track read statistics by tracking the count and Mbyte size of read requests processed per source.

Performance Diagnosis Examples

In some embodiments, a system administrator and/or user may query the storage subsystem for the metrics, and check for imbalances. For example, if the system administrator discovers that some NVMe queues have significantly larger average queue depth than others, the system administrator may identify the problem to be due to applications/hypervisor/OS issuing the writes in an imbalanced way. Similarly, if the user identifies a significantly higher WA on stream 1 compared to stream 2, for example, then the user may investigate options to split stream 1 into multiple streams which have more consistent write-velocity.

SLA-Control (and Software Defined Storage (SDS)) Examples

In accordance with some embodiments, an intelligent SLA-control engine may dynamically monitor and adjust the usage of the various resources, as indicated by the metrics. In some embodiments, the SLA-control engine may create intentional imbalances where appropriate. For example, a SLA engine may place the IOs for highest-level customers on queues with the shortest queue-depths and with the highest weighted-round-robin priority. Similarly, the SLA engine might detect that the highest-level customers have high WA on their streams, for example, and may rebalance by allocating additional streams to these customers. SDS may include technology for policy-based provisioning and/or management of data storage independent of the underlying hardware. SDS technology may be utilized by cloud service providers to enable a software defined storage system where storage properties and policies may be configured on the fly. In accordance with some embodiments, an intelligent SDS-control engine may dynamically monitor and adjust the usage of the various resources, as indicated by the metrics, based on the configured policies.

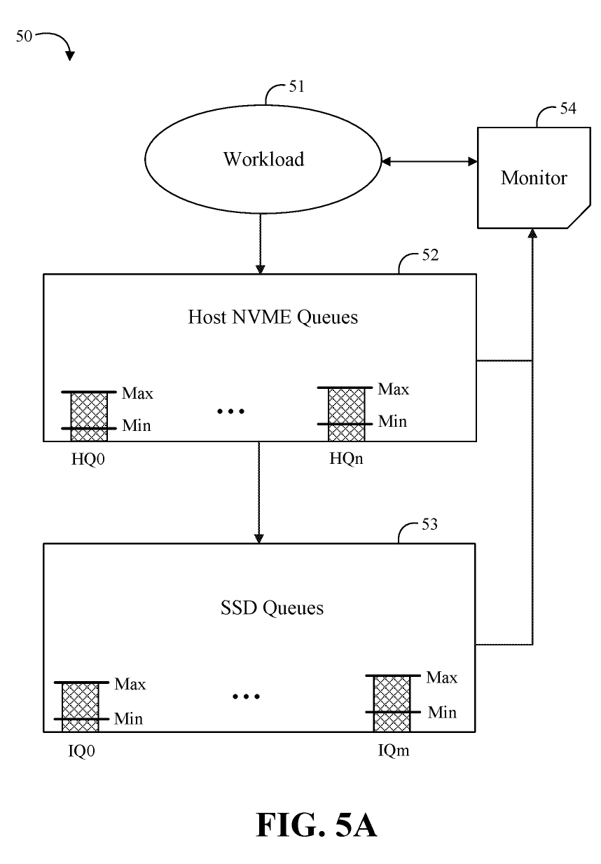

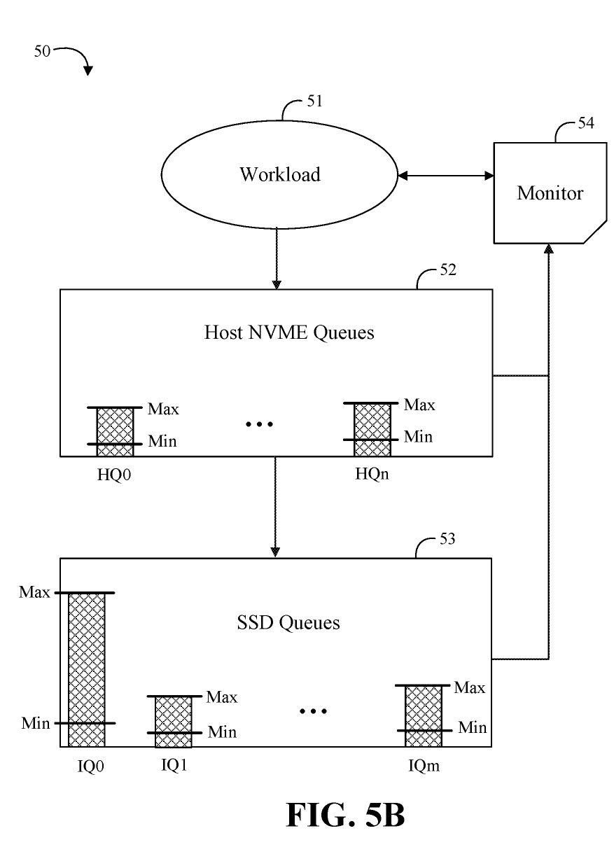

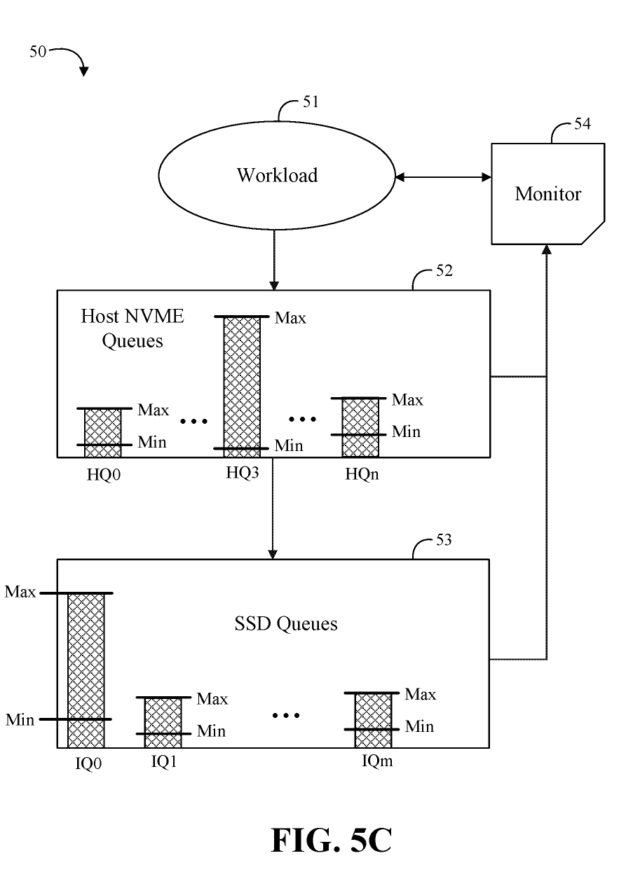

Turning now to FIGS. 5A to 5C, embodiments of a runtime environment 50 may include a workload 51 which causes IO accesses to a SSD device as indicated on host NVMe queues 52 in host memory represented as HQ0 through HQn (e.g., where n>0) and internal command scheduling SSD queues 53 internal to the SSD device represented as IQ0 through IQm (e.g., where m>0, and where the number n of HQs may be different from the number m of IQs). In some embodiments, a monitor 54 may monitor the host queues 52 and the SSD queues 53 and may adjust the workload 51 based on the monitoring.

FIG. 5A may show a balanced case where the workload 51 is equally distributing IO, and the SSD is operating well. By monitoring the respective queue depths of the hosts queues 52 and the SSD queues 53, the monitor 54 may determine that the host NVMe driver and SSD internal command scheduling queue depths are both balanced.

FIG. 5B may show an unbalanced SSD case where the workload is operating well, but there is an imbalance in the SSD queues 53. This case is an example of when the SSD may not be operating well. Accordingly, a user/administrator may focus the debug effort on the SSD. Likewise, automated rebalancing may be performed on the SSD queues 53. For example, the monitor 54 may determine that the SSD is employing a first scheduling algorithm (e.g. round robin (RR)), but a second scheduling algorithm (e.g., weighted round robin (WRR)) may be better suited to the workload 51.

FIG. 5C may show an unbalanced workload case where an application in the workload 51 may be issuing IO in an unbalanced fashion to the storage subsystem. Here both the host queues 52 and SSD queues 53 may be unbalanced and may be performing poorly because one queue (e.g., HQ3) may be executing more operations than all the others. In some embodiments, the monitor 54 may advantageously provide feedback to the host to alert the host of the imbalance such that the host may react and rebalance the workload 51. In a debug scenario, visibility into both the host queues 52 and the SSD queues 53 may help inform the debugger that the poor performance is not being caused by the SSD.

Turning now to FIG. 6, an embodiment of a method 60 of monitoring metrics may include powering on a system at block 61 and initializing a value of a maximum queue depth tracker to zero (e.g., QD_MAX=0) and a value of a minimum queue depth tracker to the maximum queue size (e.g., QD_MIN=Max_Queue_Size) at block 62. As IOs arrive at block 63, the method 60 may determine if the current queue depth (QD) is greater than QD_MAX or less than QD_MIN, and, if so, set the corresponding QD_MAX/QD_MIN to QD (e.g., to track the minimum and maximum queue depth values overall some interval). The method 60 may periodically determine whether there has been a query of the metrics at block 64 (e.g., or receive an on-demand query). If so, the method 60 may report the current values for QD_MAX and QD MIN at block 65. If not, the method 60 may periodically (e.g., or on-demand) determine whether to reset the trackers at block 66. If so, the method may proceed to initialize the trackers at block 62. Otherwise, the method 60 may return to block 63 to continue to track the minimum and maximum queue depths. For example, the method 60 may be utilized for host NVMe and SSD internal command scheduling queue depth logging and reporting. In some embodiments, the method 60 may be applied for each queue, independently, in the host NVMe driver and the SSD.

### ADDITIONAL NOTES AND EXAMPLES

Example 1 may include an electronic processing system, comprising a processor, persistent storage media communicatively coupled to the processor, and logic communicatively coupled to the processor to monitor one or more external performance indicators related to a workload impact on the persistent storage media, monitor one or more internal performance indicators for the persistent storage media, and adjust the workload based on the external performance indicators, the internal performance indicators, and priority information related to the workload.

Example 2 may include the system of Example 1, wherein the logic is further to monitor a submission queue depth for one of the external performance indicators, and monitor an internal command scheduling queue depth for one of the internal performance indicators.

Example 3 may include the system of Example 1, wherein the logic is further to monitor a write amplification parameter for one of the internal performance indicators.

Example 4 may include the system of Example 3, wherein the logic is further to monitor a plurality of write amplification parameters including one or more of a write amplification per submission queue, a write amplification per storage set, a write amplification per namespace, and a write amplification per stream.

Example 5 may include the system of Example 1, wherein the logic is further to monitor one or more of transfer buffer usage, number of writes, size of writes, number of reads, and size of reads for the external performance indicators.

Example 6 may include the system of any of Examples 1 to 5, wherein the persistent storage media comprises a solid state drive.

Example 7 may include a semiconductor apparatus, comprising one or more substrates, and logic coupled to the one or more substrates, wherein the logic is at least partly implemented in one or more of configurable logic and fixed-functionality hardware logic, the logic coupled to the one or more substrates to monitor one or more external performance indicators related to a workload impact on a persistent storage media, monitor one or more internal performance indicators for the persistent storage media, and adjust the workload based on the external performance indicators, the internal performance indicators, and priority information related to the workload.

Example 8 may include the apparatus of Example 7, wherein the logic is further to monitor a submission queue depth for one of the external performance indicators, and monitor an internal command scheduling queue depth for one of the internal performance indicators.

Example 9 may include the apparatus of Example 7, wherein the logic is further to monitor a write amplification parameter for one of the internal performance indicators.

Example 10 may include the apparatus of Example 9, wherein the logic is further to monitor a plurality of write amplification parameters including one or more of a write amplification per submission queue, a write amplification per storage set, a write amplification per namespace, and a write amplification per stream.

Example 11 may include the apparatus of Example 7, wherein the logic is further to monitor one or more of transfer buffer usage, number of writes, size of writes, number of reads, and size of reads for the external performance indicators.

Example 12 may include the apparatus of any of Examples 7 to 11, wherein the persistent storage media comprises a solid state drive.

Example 13 may include a method of controlling persistent storage, comprising monitoring one or more external performance indicators related to a workload impact on a persistent storage media, monitoring one or more internal performance indicators for the persistent storage media, and adjusting the workload based on the external performance indicators, the internal performance indicators, and priority information related to the workload.

Example 14 may include the method of Example 13, further comprising monitoring a submission queue depth for one of the external performance indicators, and monitoring an internal command scheduling queue depth for one of the internal performance indicators.

Example 15 may include the method of Example 13, further comprising monitoring a write amplification parameter for one of the internal performance indicators.

Example 16 may include the method of Example 15, further comprising monitoring a plurality of write amplification parameters including one or more of a write amplification per submission queue, a write amplification per storage set, a write amplification per namespace, and a write amplification per stream.

Example 17 may include the method of Example 13, further comprising monitoring one or more of transfer buffer usage, number of writes, size of writes, number of reads, and size of reads for the external performance indicators.

Example 18 may include the method of any of Examples 13 to 17, wherein the persistent storage media comprises a solid state drive.

Example 19 may include at least one computer readable medium, comprising a set of instructions, which when executed by a computing device, cause the computing device to monitor one or more external performance indicators related to a workload impact on a persistent storage media, monitor one or more internal performance indicators for the persistent storage media, and adjust the workload based on the external performance indicators, the internal performance indicators, and priority information related to the workload.

Example 20 may include the at least one computer readable medium of Example 19, comprising a further set of instructions, which when executed by the computing device, cause the computing device to monitor a submission queue depth for one of the external performance indicators, and monitor an internal command scheduling queue depth for one of the internal performance indicators.

Example 21 may include the at least one computer readable medium of Example 19, comprising a further set of instructions, which when executed by the computing device, cause the computing device to monitor a write amplification parameter for one of the internal performance indicators.

Example 22 may include the at least one computer readable medium of Example 21, comprising a further set of instructions, which when executed by the computing device, cause the computing device to monitoring a plurality of write amplification parameters including one or more of a write amplification per submission queue, a write amplification per storage set, a write amplification per namespace, and a write amplification per stream.

Example 23 may include the at least one computer readable medium of Example 19, comprising a further set of instructions, which when executed by the computing device, cause the computing device to monitoring one or more of transfer buffer usage, number of writes, size of writes, number of reads, and size of reads for the external performance indicators.

Example 24 may include the at least one computer readable medium of any of Examples 19 to 23, wherein the persistent storage media comprises a solid state drive.

Example 25 may include a storage controller apparatus, comprising means for monitoring one or more external performance indicators related to a workload impact on a persistent storage media, means for monitoring one or more internal performance indicators for the persistent storage media, and means for adjusting the workload based on the external performance indicators, the internal performance indicators, and priority information related to the workload.

Example 26 may include the apparatus of Example 25, further comprising means for monitoring a submission queue depth for one of the external performance indicators, and means for monitoring an internal command scheduling queue depth for one of the internal performance indicators.

Example 27 may include the apparatus of Example 25, further comprising means for monitoring a write amplification parameter for one of the internal performance indicators.

Example 28 may include the apparatus of Example 27, further comprising means for monitoring a plurality of write amplification parameters including one or more of a write amplification per submission queue, a write amplification per storage set, a write amplification per namespace, and a write amplification per stream.

Example 29 may include the apparatus of Example 25, further comprising means for monitoring one or more of transfer buffer usage, number of writes, size of writes, number of reads, and size of reads for the external performance indicators.

Example 30 may include the apparatus of any of Examples 25 to 29, wherein the persistent storage media comprises a solid state drive.

Embodiments are applicable for use with all types of semiconductor integrated circuit (“IC”) chips. Examples of these IC chips include but are not limited to processors, controllers, chipset components, programmable logic arrays (PLAs), memory chips, network chips, systems on chip (SoCs), SSD/NAND controller ASICs, and the like. In addition, in some of the drawings, signal conductor lines are represented with lines. Some may be different, to indicate more constituent signal paths, have a number label, to indicate a number of constituent signal paths, and/or have arrows at one or more ends, to indicate primary information flow direction. This, however, should not be construed in a limiting manner. Rather, such added detail may be used in connection with one or more exemplary embodiments to facilitate easier understanding of a circuit. Any represented signal lines, whether or not having additional information, may actually comprise one or more signals that may travel in multiple directions and may be implemented with any suitable type of signal scheme, e.g., digital or analog lines implemented with differential pairs, optical fiber lines, and/or single-ended lines.

Example sizes/models/values/ranges may have been given, although embodiments are not limited to the same. As manufacturing techniques (e.g., photolithography) mature over time, it is expected that devices of smaller size could be manufactured. In addition, well known power/ground connections to IC chips and other components may or may not be shown within the figures, for simplicity of illustration and discussion, and so as not to obscure certain aspects of the embodiments. Further, arrangements may be shown in block diagram form in order to avoid obscuring embodiments, and also in view of the fact that specifics with respect to implementation of such block diagram arrangements are highly dependent upon the platform within which the embodiment is to be implemented, i.e., such specifics should be well within purview of one skilled in the art. Where specific details (e.g., circuits) are set forth in order to describe example embodiments, it should be apparent to one skilled in the art that embodiments can be practiced without, or with variation of, these specific details. The description is thus to be regarded as illustrative instead of limiting.

The term “coupled” may be used herein to refer to any type of relationship, direct or indirect, between the components in question, and may apply to electrical, mechanical, fluid, optical, electromagnetic, electromechanical or other connections. In addition, the terms “first”, “second”, etc. may be used herein only to facilitate discussion, and carry no particular temporal or chronological significance unless otherwise indicated.

As used in this application and in the claims, a list of items joined by the term “one or more of” may mean any combination of the listed terms. For example, the phrase “one or more of A, B, and C” and the phrase “one or more of A, B, or C” both may mean A; B; C; A and B; A and C; B and C; or A, B and C.

Those skilled in the art will appreciate from the foregoing description that the broad techniques of the embodiments can be implemented in a variety of forms. Therefore, while the embodiments have been described in connection with particular examples thereof, the true scope of the embodiments should not be so limited since other modifications will become apparent to the skilled practitioner upon a study of the drawings, specification, and following claims.

We claim:

1. An electronic processing system, comprising:
a processor;
persistent storage media communicatively coupled to the processor; and
logic communicatively coupled to the processor to:
monitor one or more external performance indicators related to a workload impact on the persistent storage media,
monitor one or more internal performance indicators for the persistent storage media, and
adjust the workload based on the external performance indicators, the internal performance indicators, and priority information related to the workload.

2. The system of claim 1, wherein the logic is further to:
monitor a submission queue depth for one of the external performance indicators; and
monitor an internal command scheduling queue depth for one of the internal performance indicators.

3. The system of claim 1, wherein the logic is further to:
monitor a write amplification parameter for one of the internal performance indicators.

4. The system of claim 3, wherein the logic is further to:
monitor a plurality of write amplification parameters including one or more of a write amplification per submission queue, a write amplification per storage set, a write amplification per namespace, and a write amplification per stream.

5. The system of claim 1, wherein the logic is further to:
monitor one or more of transfer buffer usage, number of writes, size of writes, number of reads, and size of reads for the external performance indicators.

6. The system of claim 1, wherein the persistent storage media comprises a solid state drive.

7. A semiconductor apparatus, comprising:
one or more substrates; and
logic coupled to the one or more substrates, wherein the logic is at least partly implemented in one or more of configurable logic and fixed-functionality hardware logic, the logic coupled to the one or more substrates to:
monitor one or more external performance indicators related to a workload impact on a persistent storage media,
monitor one or more internal performance indicators for the persistent storage media, and
adjust the workload based on the external performance indicators, the internal performance indicators, and priority information related to the workload.

8. The apparatus of claim 7, wherein the logic is further to:
monitor a submission queue depth for one of the external performance indicators; and
monitor an internal command scheduling queue depth for one of the internal performance indicators.

9. The apparatus of claim 7, wherein the logic is further to:
monitor a write amplification parameter for one of the internal performance indicators.

10. The apparatus of claim 9, wherein the logic is further to:
monitor a plurality of write amplification parameters including one or more of a write amplification per submission queue, a write amplification per storage set, a write amplification per namespace, and a write amplification per stream.

11. The apparatus of claim 7, wherein the logic is further to:
monitor one or more of transfer buffer usage, number of writes, size of writes, number of reads, and size of reads for the external performance indicators.

12. The apparatus of claim 7, wherein the persistent storage media comprises a solid state drive.

13. A method of controlling persistent storage, comprising:
monitoring one or more external performance indicators related to a workload impact on a persistent storage media;
monitoring one or more internal performance indicators for the persistent storage media; and
adjusting the workload based on the external performance indicators, the internal performance indicators, and priority information related to the workload.

14. The method of claim 13, further comprising:
monitoring a submission queue depth for one of the external performance indicators; and
monitoring an internal command scheduling queue depth for one of the internal performance indicators.

15. The method of claim 13, further comprising:
monitoring a write amplification parameter for one of the internal performance indicators.

16. The method of claim 15, further comprising:
monitoring a plurality of write amplification parameters including one or more of a write amplification per submission queue, a write amplification per storage set, a write amplification per namespace, and a write amplification per stream.

17. The method of claim 13, further comprising:
monitoring one or more of transfer buffer usage, number of writes, size of writes, number of reads, and size of reads for the external performance indicators.

18. The method of claim 13, wherein the persistent storage media comprises a solid state drive.

19. At least one computer readable medium, comprising a set of instructions, which when executed by a computing device, cause the computing device to:
monitor one or more external performance indicators related to a workload impact on a persistent storage media;
monitor one or more internal performance indicators for the persistent storage media; and
adjust the workload based on the external performance indicators, the internal performance indicators, and priority information related to the workload.

20. The at least one computer readable medium of claim 19, comprising a further set of instructions, which when executed by the computing device, cause the computing device to:
monitor a submission queue depth for one of the external performance indicators; and
monitor an internal command scheduling queue depth for one of the internal performance indicators.

21. The at least one computer readable medium of claim 19, comprising a further set of instructions, which when executed by the computing device, cause the computing device to:
monitor a write amplification parameter for one of the internal performance indicators.

22. The at least one computer readable medium of claim 21, comprising a further set of instructions, which when executed by the computing device, cause the computing device to:
monitoring a plurality of write amplification parameters including one or more of a write amplification per submission queue, a write amplification per storage set, a write amplification per namespace, and a write amplification per stream.

23. The at least one computer readable medium of claim 19, comprising a further set of instructions, which when executed by the computing device, cause the computing device to:
monitoring one or more of transfer buffer usage, number of writes, size of writes, number of reads, and size of reads for the external performance indicators.

24. The at least one computer readable medium of claim 19, wherein the persistent storage media comprises a solid state drive.
